(19) United States
(12) Patent Application Publication
(10) Pub. No.: US 2025/0051223 A1
(43) Pub. Date: Feb. 13, 2025

(54) DEVICE FOR HOLDING A TUBULAR SIO2 BLANK IN AN EXTERNAL DEPOSITION PROCESS AND METHOD FOR MANUFACTURING A TUBULAR SIO2 BLANK

(71) Applicant: Heraeus Quarzglas GmbH & Co. KG, Hanau (DE)

(72) Inventors: Walter LEHMANN, Kleinostheim (DE); Klaus-Uwe BADEKE, Bitterfeld-Wolfen (DE)

(21) Appl. No.: 18/791,985

(22) Filed: Aug. 1, 2024

(30) Foreign Application Priority Data
Aug. 8, 2023 (EP) 23190222.2

(51) Int. Cl. C03C 17/00; C03C 17/02

(52) U.S. Cl. CPC C03C 17/005; C03C 17/02; C03C 2201/02; C03C 2217/213

(57) ABSTRACT

A device for producing a tubular SiO₂ blank in an external deposition process has a substrate tube and a substrate tube holder comprising a clamping device, which is designed to support the substrate tube and to rotate the substrate tube about an axis of rotation. In order to provide, on this basis, a reproducible and operationally reliable holder for a large-volume, tubular SiO₂ blank in an external deposition process, it is proposed that the substrate tube holder comprise a clamping mechanism which has a first pressure unit abutting the first substrate tube end face, a second pressure unit abutting the second substrate tube end face, and at least one force element which is designed to generate an axial contact pressure with a force component acting in the direction of the longitudinal axis of the substrate tube.

### CROSS-REFERENCE TO RELATED APPLICATIONS

This application claims priority pursuant to 35 U.S.C. 119(a) to European Application No. 23190222.2, filed Aug. 8, 2023, which application is incorporated herein by reference in its entirety.

### FIELD OF THE INVENTION

The present invention relates to a device for producing a tubular SiO₂ blank in an external deposition process, comprising:
a substrate tube which has a substrate tube longitudinal axis, a substrate tube length, a first substrate tube end face, a second substrate tube end face, a substrate tube outer lateral surface, a substrate tube inner lateral surface, a substrate tube outer diameter, a substrate tube inner diameter, a substrate tube wall thickness, and a continuous through-opening running coaxially with the substrate tube longitudinal axis,
and a substrate tube holder which comprises a clamping device and which is designed to support the substrate tube and to rotate the substrate tube about an axis of rotation running coaxially with or parallel to the longitudinal axis of the substrate tube.

The invention also relates to a method for producing a tubular SiO₂ blank in an external deposition process, comprising the following method steps:
(a) providing a substrate tube which has a substrate tube longitudinal axis, a substrate tube length, a first substrate tube end face, a second substrate tube end face, a substrate tube outer lateral surface, a substrate tube inner lateral surface, a substrate tube outer diameter, and a continuous through-opening running coaxially with the substrate tube longitudinal axis,
(b) supporting the substrate tube in a substrate tube holder comprising a clamping device,
(c) rotating the substrate tube about an axis of rotation running coaxially with or parallel to the longitudinal axis of the substrate tube, and
(d) depositing SiO₂ particles on the outer lateral surface of the substrate tube by means of at least one deposition burner, forming the tubular SiO₂ blank.

### BACKGROUND OF THE INVENTION

Components made of synthetic quartz glass in the form of preforms, tubes, rods, flanges, plates, rings, reactors, crucibles, and the like are used in semiconductor production and for the manufacture of optical fibers. Such components are often produced from tubular blanks made of synthetic silicon dioxide by thermally forming and/or mechanically processing them. In the course of increases in productivity, larger dimensions are increasingly being sought for such components, and in particular greater wall thicknesses and internal diameters.

For the production of tubular blanks from synthetically produced silicon dioxide, CVD processes (chemical vapor deposition) are known, in which SiO₂ particles are deposited from the gas phase on a substrate. The CVD external deposition process known by the abbreviation, “OVD” (outside vapor deposition), is generally suitable for the production of large-volume blanks. In this process, a silicon-containing starting material is converted into SiO₂ particles in a reaction zone by means of flame hydrolysis or pyrolysis, and these particles are deposited in layers on the outer jacket of a cylindrical substrate rotating around its longitudinal axis. The reaction zone is generated by means of a heat source, wherein the substrate longitudinal axis and the heating source move back and forth relative to one another. The substrate can be tubular and is also referred to here and in the following as a “substrate tube.” The substrate tube consists, for example, of SiC, SiSiC (reaction-bonded silicon carbide), Al₂O₃, or another ceramic material, or of graphite, and is held and rotated about its longitudinal axis by means of a lathe-like device, which is also referred to here as a “substrate tube holder.”

The result of this deposition process is a substantially cylindrical, tubular SiO₂ blank which, depending on the temperature during the deposition process, is either a porous SiO₂ body (also referred to below as a “soot body”) or a body made of more or less transparent quartz glass. In the case of a porous soot body, this body is sintered in a separate method step to form a body of more or less transparent quartz glass (the sintering process is also referred to as “vitrification”). From the body of more or less transparent quartz glass, a component of synthetic quartz glass is obtained by mechanical, chemical, and/or thermal post-processing, such as a solid cylinder, a hollow cylinder, or parts of these components, which themselves can also serve as semi-finished products for the production of other components.

To produce a SiO₂ body from synthetic silicon dioxide with a large internal tube diameter using the external deposition process, it is necessary to use a substrate tube with a suitable external diameter and a substrate tube holder adapted to it. The basic problem that arises here is to compensate as far as possible for the differences in the linear thermal expansion coefficients (also referred to below as thermal expansion or CTE (coefficient of thermal expansion)) of the materials of the SiO₂ body, substrate tube, and substrate tube holder.

For example, the horizontal lathe known from EP 3 584 023 A1 for producing a preform from porous silicon dioxide using the OVD method has a mechanism for compensating for thermal expansion in the axial direction. This mechanism comprises a clamping device with a first chuck which can rotate about the axis of rotation and which grips one of the ends of the substrate tube, and a second chuck which grips the other end of the substrate tube and which can be moved back and forth in the direction of the axis of rotation. This back-and-forth mobility is made possible, for example, by a roller bearing of the second chuck, advantageously supplemented by a spring preloading which counteracts the axial elongation due to the thermal expansion.

KR 10-2452282 B1 describes an OVD external deposition process for manufacturing a quartz glass tube, and a device for this purpose. A stepped substrate tube is proposed which is formed from a cylindrical deposit part with a large outer diameter, to which are connected clamping parts which project outwardly on both sides and have a smaller outer diameter, which clamping parts fit into the clamping jaws of a horizontal glass lathe. The deposit part and the clamping parts on both sides can be realized in one piece, or the deposit part is connected to the clamping parts on both sides. Screws, pins, and latching connections are mentioned as connecting means, and, alternatively, embodiments in which the support part or the deposit part are provided with a screw thread and are connected in a screw method. In the OVD deposition process, a SiO₂ soot body is produced on the cylindrical lateral surface of the deposit part, while this soot body is rotated around an axis of rotation by means of the clamping parts on both sides.

### Technical Problem

In the OVD external separation process, the substrate tube heats up more on the outside than on the inside. The resulting mechanical stresses accumulate over the wall thickness and can lead to breakage. With a small substrate tube diameter of less than 80 mm, for example, and a small substrate tube length of less than 2,000 mm, for example, the CTE differences are not so serious and have an effect almost exclusively in the axial direction (in the direction of the longitudinal axis of the substrate tube). In the case of large and thick-walled substrate pipes with an internal diameter of more than 200 mm and a wall thickness of more than 25 mm, for example, the radial thermal expansion is, however, no longer negligible. These substrate tubes also have a high weight, which increases the requirements for stability and dynamics of the substrate tube holder.

The reaction region in which the deposition process takes place usually has a shorter axial dimension compared to the substrate tube length. The substrate tube clamped at both ends is heated only in the narrow length section of the deposition region, but not as strongly at the end regions held in the substrate tube holder. The thermal stresses between the colder end regions and the hotter middle of the tube can also cause the substrate tube to crack.

In devices for the production of large-volume tubular blanks from synthetic silicon dioxide using an OVD external deposition process and correspondingly large device components, weight, local temperature differences within a component and CTE differences between different components connected to one another increasingly make the manufacturing process more difficult.

The object of the invention is therefore that of providing a device which avoids at least some of the above-mentioned disadvantages and which is suitable in particular for reproducibly and reliably holding a large-volume, tubular SiO₂ blank by means of an external deposition process, and in particular an OVD external deposition process.

In particular, the object of the invention is that of providing a device for holding a thick-walled tubular blank with a large internal diameter, for example with an external diameter of more than 200 mm and a large wall thickness of more than 25 mm, in an external deposition process, which is suitable for avoiding or compensating for mechanical stresses due to dimensional deviations and calibration, alignment, and adjustment errors in components of the device and due to CTE differences of components in the axial direction and in the radial direction.

Furthermore, the object of the invention is that of providing a method for manufacturing a tubular blank—in particular, from synthetic silicon dioxide—with a large internal diameter and a large wall thickness according to the external deposition process, and in particular with an internal tube diameter of more than 200 mm and with a tube wall thickness of more than 25 mm, which avoids the above-mentioned disadvantages and in which, in particular, the risk of rejects is reduced.

### SUMMARY

With regard to the device, this object is achieved according to the invention proceeding from a device of the type mentioned at the outset in that the substrate tube holder comprises a clamping mechanism which has a first pressure unit abutting the first substrate tube end face, a second pressure unit abutting the second substrate tube end face, and at least one force element which is designed to generate an axial contact pressure with a force component acting in the direction of the substrate tube longitudinal axis, which causes the substrate tube to be clamped between the first pressure unit and the second pressure unit.

The substrate tube is designed to support a tubular SiO₂ body—in particular, made of synthetic silicon dioxide—with a large internal diameter on its outer lateral surface on the basis of an external deposition process. The tubular SiO₂ body is, for example, a SiO₂ soot body or a body made of partially or completely densely sintered quartz glass.

The substrate tube has, for example, a substrate tube length up to 4 m and is cylindrical, conical, or stepped over its entire length or over part of its length. The inner contour is constant over the length of the substrate tube, or it changes.

After completion of the deposition process, the substrate tube can remain in the composite of substrate tube and SiO₂ blank, or it can be removed from the substrate tube-blank composite. A substrate tube that remains in the substrate tube-SiO₂ body composite can become a part of the SiO₂ blank; it is made of quartz glass, for example. A substrate tube that remains in the substrate tube-SiO₂ body composite and becomes part of the SiO₂ blank preferably has an inner diameter of at least 250 mm. Its wall thickness is preferably in the range of 4 mm to 10 mm, as appropriate.

A substrate tube, which is removed from the substrate tube-SiO₂ body composite after the deposition process or at a later stage of the process, is preferably made of SiC, SiSiC, Al₂O₃, or another ceramic material, or of graphite. It preferably has an outer diameter of at least 250 mm. Its wall thickness is, optionally, preferably in the range from 5 to 30 mm.

The wall thickness of the substrate tube is thus small relative to its outer diameter and is preferably less than 20% of the outer diameter of the substrate tube. On the one hand, the substrate tube thus has a low weight, which reduces the dynamics of the rotational movement and facilitates handling and alignment, and on the other it has a low thermal mass, which keeps the heat dissipation and the formation of thermal stresses within the wall low.

On the other hand, the wall thickness of the substrate tube is large enough to support a large-volume SiO₂ body. Therefore, the wall thickness of the substrate tube is preferably at least 1% of the outer diameter of the substrate tube.

The wall thickness “W_{S}” (in mm) can also depend on the length of the substrate tube. It is advantageous if the wall thickness also increases with increasing length of the substrate tube. Therefore, W_{S} can alternatively be set depending on the outer diameter D_{S} of the substrate tube (in mm), additionally taking into consideration the length of the substrate tube “L_{S}” (in mm), as follows: W_{S}<0.2*(L_{S}/2,000 mm)*D_{S}.

The substrate tube holder for supporting and rotating the substrate tube comprises the clamping device and a clamping mechanism with two pressure units, one of which rests against each end face of the substrate tube. The clamping mechanism causes the substrate tube to be clamped by applying an axial clamping force to its end faces at both sides. For this axial clamping, the applied axial clamping force and, in the simplest case, a non-positive connection based solely on friction between the substrate tube and the pressure units abutting the end faces is sufficient. The elimination of the otherwise usual positive-fit or material connection between the substrate tube and the clamping device results in an additional degree of freedom for movements of the substrate tube in the radial direction and, in this respect, a certain mechanical decoupling of the substrate tube from the clamping device, even if the pressure units are fixedly connected to the clamping device. As a result, thermally induced changes in the diameter of the substrate tube that occur during the deposition process can be compensated for, or these diameter changes can be permitted without mechanical stresses building up between the clamping device and the substrate tube.

The clamping mechanism can also contribute to compensating for thermal expansion in the direction of the substrate tube longitudinal axis.

The first pressure unit and the second pressure unit preferably each comprise a contact pressure surface which abuts the corresponding substrate tube end face and consists of a graphite-containing material. The graphite-containing material is comparatively soft and can absorb shocks and impulses. This is explained in more detail below.

The pressure units on both sides transmit both the rotational movement of the clamping device and the component of the contact pressure generated by the at least one force element and acting in the direction of the substrate tube longitudinal axis onto the substrate tube end faces. In the simplest case, the rotational movement of the substrate tube can also be achieved solely by the axial non-positive connection (static friction) between the substrate tube and the contact pressure units abutting the end faces of the substrate tube. Only a sufficiently high contact pressure is required for this purpose. Supporting this, driver elements can be provided on the end face of the substrate tube and/or on one or both of the pressure units that abut it, which driver elements create a positive fit for the rotational movement and do not eliminate the above-mentioned additional degree of freedom for movements of the substrate tube in the radial direction.

The pressure units themselves on both sides each consist of one component or of several components. In the preferred case, they are identical in design. The components directly abutting the end faces of the substrate tube are, for example, plate-shaped or ring-shaped, or form spherical or ellipsoidal segments. In the simplest case, the surfaces abutting the substrate tube end faces are flat; they can also be designed to be curved or stepped.

The first and second pressure units are pressed against each other as a result of the action of the at least one force element, so that the pressure units exert an axial contact pressure on the substrate tube that is sufficient for the support and rotational movement of the substrate tube. It is sufficient for this if the at least one force element acts on only one of the two pressure units, so that this pressure unit transmits the contact pressure to the respective substrate tube end face; if necessary, the other pressure unit—situated opposite in the direction of the substrate tube longitudinal axis—forms a passive abutment without the need for a further force element.

In a preferred embodiment of the device, the clamping device comprises a first spindle which can rotate about the axis of rotation and a second spindle which is situated axially opposite the first spindle in the direction of the longitudinal axis of the substrate tube and can rotate about the axis of rotation, wherein the first spindle is mounted on or linked to the first pressure unit in a rotationally fixed but pivotable manner and transmits the axial contact pressure to this first pressure unit, and wherein the second spindle is mounted on or linked to the second pressure unit so as to be rotationally fixed but movable relative to one another and transmits the axial contact pressure to this second pressure unit.

The first spindle (for example, on the left-hand side) and the second spindle (for example, on the right-hand side) are each assigned to a pressure unit. They form mechanical guide elements for their respective pressure unit; they transmit the rotational movement of the clamping device and the axial contact pressure to their respective pressure units. The spindles are designed in one piece or consist of several components; in the simplest case, for example, they are designed as a tube, solid rod, or cone. Each of the two spindles is connected to its corresponding pressure unit for force transmission. The connection is rotationally fixed, but allows at least a pivoting movement.

For example, it is designed as a joint, such as a hinge, ball joint, universal joint, or cardan joint, or as a fixed bearing or floating bearing, such as a ball bearing, conical bearing, roller bearing, or cardan bearing or mount. This pivoting connection between the pressure unit and the spindle results in an additional decoupling between the clamping device and the substrate tube, which helps to compensate for alignment, positional, or dimensional deviations. For example, in this way, end faces that are not exactly perpendicular to the longitudinal axis of the substrate tube can be compensated for, and wobbling movements caused by the substrate tube not being absolutely precisely centered can be compensated for.

In the simplest and particularly preferred case, the first spindle has a free, distal end on which the first pressure unit is pivotably mounted, and the second spindle also has a free distal end on which the second pressure unit is pivotably mounted.

The two spindles therefore transfer the contact pressure and the rotational movement to the substrate tube on the one hand, and support the pressure units on the other. These units are seated on the corresponding distal spindle end.

In the region of the distal end of the first and second spindle, in each case there is arranged at least one support element on which the corresponding spindle can roll. The at least one support element is used to support the spindle, and especially when the substrate tube and SiO₂ body are heavy in weight.

Particularly preferably, the pivoting connection between the spindle and the pressure unit is designed as a floating bearing and preferably comprises a cardan ball cone seat. Here, the seat on the spindle side is conical in shape, and the pressure unit movably mounted thereon has a spherical or radius section that interacts with the seat—or conversely: the seat on the spindle side has a convexly curved spherical or radius section that corresponds with the concavely curved pressure unit movably mounted thereon.

In particular, in the case of very long substrate tubes having a length of more than 2 m, an additional stabilization of the axis of rotation can be helpful. With regard to this, the substrate tube holder comprises a centering unit comprising at least one tubular or rod-shaped centering support extending through the through-opening of the substrate tube and between the first pressure unit and the second pressure unit.

The centering support is preferably mounted loosely in the region of the respective pressure units and is mechanically decoupled from the spindles on both sides in such a way that it does not hinder the axial movement of the spindles to compensate for changes in length.

For example, a linkage can be used for this purpose which extends through the through-opening in the substrate tube from one spindle to the opposite spindle. The linkage consists, for example, of a rod or of several rods which are each uniformly distributed about the axis of rotation and are connected directly or indirectly (via the corresponding mounted intermediate element) to the spindles on both sides.

Alternatively or in addition, in a particularly preferred embodiment, it is provided that the first spindle be designed as a hollow spindle having a first inner bore, and that the second spindle be designed as a hollow spindle with a second inner bore, and that the centering support project with a first end into the first inner bore and with a second end into the second inner bore.

The first and the second spindle are here designed as hollow spindles with inner bores. The inner bores are either designed as through-holes, or the hollow spindles are closed at one side at their proximal end (facing the clamping device). In the simplest case, the inner bores have a circular cross-section; however, they can also have a cross-section deviating from the circular shape, such as an oval or a polygonal cross-section. The internal cross-sections of the first hollow spindle and of the second hollow spindle are the same or different from one another. The internal cross-sections of the hollow spindles are adapted to the respective external cross-sections of the centering supports—preferably in the sense of a clearance fit.

The centering support, which is part of the centering unit, has a centering support longitudinal axis and is for example rod-shaped or tubular. It extends completely through the through-opening of the substrate tube, but preferably ends in the inner bores of the hollow spindles on both sides. In the corresponding inner bore, the centering support is mounted according to the telescopic principle so as to be axially displaceable with little radial play. The gap between the inner wall of the hollow spindle and the outer wall of the centering support is as small as possible and is preferably in the range of a few tenths of a millimeter—for example, 0.2-0.5 mm. The centering support is thus supported on the inner wall of the inner bores of both hollow spindles and simultaneously centers them relative to one another in the axial direction in the sense of a coaxiality of the longitudinal axes of centering supports and hollow spindles. On the one hand, the clearance fit prevents overdetermination of the substrate tube bearing, and, on the other, an axial guidance is achieved that counteracts mutual tilting or twisting of the hollow spindles from the longitudinal axis of the substrate tube.

In a preferred embodiment of the centering support, this support is freely rotatable within the hollow spindle inner bores on both sides and does not also execute the hollow spindle rotational movement, or does so only partially. In another embodiment of the centering support, it is mounted in rotationally fixed fashion inside the inner bores of the hollow spindle inner bores on both sides, so that it rotates along with the hollow spindles. The rotatably fixed mounting can be achieved, for example, by a non-circular inner geometry of at least one of the hollow spindles, for example by a polygonal or oval inner geometry, and an outer contour of the centering support adapted thereto in the sense of a key-lock combination.

In a preferred development of the embodiment with centering support, it is freely movable in the axial direction in the first inner bore and in the second inner bore.

Here, the centering support ends inside the respective inner bores and can move freely therein in the axial direction (apart from friction). Due to the axial mobility of the centering support, differences in the thermal expansion between the centering support and the hollow spindles can be compensated for, and thus thermally induced stresses in the substrate tube holder can be avoided.

The free distance “a” between the oppositely situated hollow spindles is generally constant. The length of the centering support “L_{Z}” is greater than this free distance “a”. Under certain circumstances, the centering support can nevertheless slip completely out of one of the hollow spindle inner bores, if its movement play in the axial direction is large enough for this. This slipping out can be prevented, for example, by the length of the centering support “L_{Z}” comprising the free distance “a” plus an additional length (La+Lb) that takes into account the axial movement clearances on both sides in the first and second inner bores.

In particular, with regard to the effect of the centering support as an axial guide for the hollow spindles on both sides, it is advantageous if the centering support extends into both hollow spindles over a certain extension length La or Lb. The lengths La or Lb are preferably at least twice as large as the inner diameter of the respective hollow spindle. The inner diameter of the hollow spindles is preferably in the range of 40 mm to 100 mm.

On the other hand, for reasons of stability and in particular for the most effective possible guidance of the hollow spindles on both sides by means of the centering support, it can also be advantageous to limit the entire axial movement range “B_{Z}” (Bₐ+B_{b}) of the centering support on both sides inside the hollow spindles and to design “B_{Z}” to be as large as necessary, but as small as possible. With regard to this, it has proven useful if the following applies for B_{Z}: B_{Z}<20 mm, and preferably 5 mm<B_{Z}<15 mm.

The entire axial movement clearance of the centering support inside the hollow spindles in the axial direction is limited to a few millimeters. This is usually sufficient to compensate for the CTE differences between the hollow spindles and the centering support in the axial direction. The limitation can take place, for example, by stop elements projecting into the inner bores of the hollow spindles, or by a narrowing, or by a closure of the inner bores of the hollow spindles.

In a particularly preferred development of the embodiment of the device having a centering support, it is provided that the centering unit comprise centering elements which are placed on the centering support inside the through-hole in the substrate tube, and of which a first centering element is arranged in the region of the first substrate tube end face, and a second centering element is arranged in the region of the second substrate tube end face.

The centering elements are inserted into the substrate tube through-hole in the region of both ends. They serve to guide the substrate tube and act as a “collapse protection” against slipping out. Accordingly, they have an outer contour which is adapted to the inner contour of the substrate tube through-hole. They are designed, for example, as a circular ring, polygonal ring, or in a star shape with outwardly pointing support arms. The diameter of the enveloping circle around the centering element is smaller than the inside diameter of the substrate tube through-hole. The inner contour of the centering elements is preferably adapted to the outer contour of the centering support in such a way that they are seated on the centering support with a clearance fit in a sliding manner. For example, in the case of a circular configuration, the inner diameter of the centering elements is larger by 0.5 to 2 mm than the outer diameter of the centering support.

The centering elements facilitate the installation of the substrate tube holder and reduce the risk of the substrate tube slipping out of the axial clamping when used in the deposition process. To reduce the deflection of the substrate tube, at least one further centering element can be arranged in the region between the end centering elements. The centering elements preferably consist of graphite or of another graphite-containing material.

The SiO₂ blank to be produced generally consists of synthetic silicon dioxide, whose CTE is low. It varies depending on the composition and production method, and at room temperature is about 0.5 μm/m/° K (0.5×10⁻⁶/° K). A metal is preferably selected as the material for the spindles. Metals are generally distinguished by their ability to absorb mechanical energy during plastic deformation (toughness) and are therefore able to compensate for mechanical impulses during the deposition process. Particular preference is given to metals having high chemical resistance, such as stainless steel (with a CTE in the range of 10 μm/m/° K to 17 μm/m/° K, depending on the alloy), and/or metals having a coefficient of thermal expansion comparable to silicon dioxide, such as iron nickel alloys known under the collective designation, “INVAR,” the CTE of which is typically in the range of 1.2 μm/m/° K or below.

The at least one deposition burner generates a burner flame, the hottest point of which is generally located spatially in front of or on the surface of the SiO₂ body to be deposited. The region around this hottest point is also known as the “reaction region.”

With regard to this, in a preferred embodiment of the device, the maximum dimension of the spindles in the radial direction, such as the outer diameter in the case of a circular spindle cross-section, is significantly smaller than the substrate tube outer diameter; for example, it is at least 100 mm smaller. This ensures that the spindles are outside the “reaction region” of the deposition burner or burners.

The device has a first side (for example, the left side) and a second side (for example, the right side). When the following explanations refer only to the first of these two sides, the second side is designed to be essentially identical or equivalent to the first side, unless expressly stated otherwise.

It has proven successful if the first pressure unit has a first pressure transmission element and a first buffer element connected thereto in a rotationally fixed manner and preferably consisting of a graphite-containing material, wherein the pressure transmission element is mounted on or linked to the first spindle in a rotationally fixed but pivotable manner, and wherein the first buffer element is arranged between the pressure transmission element and the substrate tube, and abuts the first substrate tube end face.

The first pressure transmission element is part of the first pressing unit. It is designed to transmit the axial contact pressure generated by the at least one force element onto the first substrate tube end face, or to serve as an abutment for the first substrate tube end face if the axial contact pressure generated by the force element also acts, or acts exclusively, on the second substrate tube end face. The pressure transmission element interacts directly or indirectly (i.e., via an intermediate element) with the first spindle, on which or to which it is mounted or linked in a rotationally fixed but pivotable manner. For example, the pressure transmission element has a central opening with a circumferential opening edge, which rests on the first spindle. The pressure transmission element preferably consists of metal—for example, of stainless steel.

The buffer element is arranged between the pressure transmission element and the first substrate tube end face. It serves on the one hand to improve the clamping effect and on the other to absorb pulses in the axial or azimuthal direction which could otherwise act on the comparatively shock-sensitive end face. The buffer element is for example designed to be annular or star-shaped. It preferably has a low hardness and allows a comparatively high contact pressure to be applied without damaging the substrate tube end face, and it generates a high enough friction that the rotational movement is transmitted. A suitable material is, for example, graphite which, due to its lubricating property, allows a radial slippage of the tube end faces on the graphite and thus allows a radial thermal expansion of the substrate tube, but always has enough frictional force to transmit the pulses and forces during azimuthal acceleration.

The force flow of the contact pressure is here: force element (for example, a spring-loaded chuck) 4 first pressing unit with first spindle 4 joint/pivotable bearing 4 first pressure transmission element 4 first buffer element 4 first substrate tube end face.

The first buffer element can be designed as a stepped annular disk which has a hollow cylindrical section with an outwardly projecting flange, wherein the flange abuts the first substrate tube end face, and the hollow cylindrical section projects into the through-hole in the substrate tube. The stepped-disk buffer element engages under the inner wall of the substrate tube with little play and simultaneously acts as a centering element. This is one way of ensuring the position of the first centering element in the region of the first substrate tube end face, if this appears necessary or advantageous. In this embodiment, the centering element and the buffer element are designed in one piece.

On the other hand, the buffer element is exposed to high forces and can wear out comparatively quickly. It is also advantageous if the centering element and the buffer element can be thermally decoupled—for example, by a gap. As a wear part, the buffer element is preferably easy and inexpensive to replace. With this in mind, it has proven to be advantageous if the first centering element is connected to the first buffer element in a detachable and non-rotatable manner.

This is a further possibility for ensuring the positioning of the first centering element in the region of the first substrate tube end face, if this appears necessary or advantageous. The detachable connection is made using screws, for example. The buffer element can thus be easily replaced—for example, in the event of wear. The torsional strength is also ensured by connection that is only loose between the buffer element and the centering element, which on the one hand allows mechanical play, and on the other leaves a gap between the buffer element and the centering element for thermal decoupling. In this case, for example, screws are provided that are guided with play in bores in the buffer element and in the centering element so that the articulated connection between the respective spindle and the pressure unit is not hindered. The screws bring about a positive-fit connection for the rotational movement and can thus serve as driver elements for the rotational movement of the substrate tube.

When equipping the device with a first buffer element, it has also proven to be advantageous if this buffer element projects beyond the pressure transmission element and the substrate tube in the radial direction.

During the OVD external deposition process, the flame of the at least one deposition burner strikes the lateral surface of the substrate tube or the forming SiO₂ body and can then be deflected laterally so that it spreads tangentially to the body lateral surface in the direction of the end regions of the SiO₂ body. As a result of the radial protrusion of the buffer element relative to the pressure transmission element, the latter is located in the flame shadow, and is thereby largely protected from thermal and corrosive stress, to which, on the other hand, the buffer element is exposed. The height of the radial protrusion is preferably in the range of 1 cm to 3 cm.

In a preferred embodiment of the device according to the invention, the substrate tube holder comprises a compensation mechanism for compensating for thermal expansion in the direction of the substrate tube longitudinal axis. The compensation mechanism and the clamping mechanism can have common components. For example, the compensation mechanism usually comprises a spring element, wherein preferably the force element of the clamping mechanism also comprises a spring element, which is at the same time a component of the compensation mechanism. The spring element is thus both a component of the compensation mechanism and a component of the clamping mechanism of the substrate tube holder. The spring element is designed, for example, as a chuck spring-mounted on one or both sides.

With regard to the method for manufacturing a SiO₂ blank, the above-indicated technical object is achieved according to the invention based on a method of the type mentioned at the outset, in that the substrate tube holder is used to generate an axial contact pressure on the first end face and on the second end face with a force component acting in the direction of the longitudinal axis of the substrate tube, which causes the substrate tube to be clamped between a first pressure unit abutting the first end face and a second pressure unit abutting the second end face.

The method comprises a method step in which, on the basis of an external deposition process, a tubular SiO₂ blank—in particular, of synthetic silicon dioxide—is produced. Depending on the temperature during the deposition process, either a porous SiO₂ soot body or a more or less transparent vitreous SiO₂ body is produced on the lateral surface of the substrate tube. In the case of a porous SiO₂ soot body, this body can be subjected to a dehydration treatment in inert gas, chlorine-containing gas, or under vacuum to reduce the hydroxyl group content of the quartz glass before it is sintered to form the more or less transparent vitreous SiO₂ body. The sintering (or vitrification) takes place, for example, under vacuum or in an atmosphere containing helium and/or hydrogen and/or nitrogen.

The substrate tube has, for example, a substrate tube length up to 4 m and is cylindrical, conical, or stepped over its entire length or over part of its length. It is designed to produce a tubular SiO₂ body—in particular, made of synthetic silicon dioxide—with a large internal diameter on its outer lateral surface on the basis of an OVD external deposition process. The SiO₂ blank obtained after this process step has, for example, the following dimensions: an internal diameter in the range of 250 mm to 650 mm, a wall thickness in the range of 25 mm to 150 mm, and a length in the range of 800 mm to 3,800 mm. By mechanical, chemical, and/or thermal processing, a component of synthetic quartz glass is obtained therefrom—for example, a quartz glass tube or a quartz glass ring.

The method thus makes it possible, among other things, to manufacture a large-volume quartz glass tube having an internal diameter of at least 250 mm and a wall thickness of at least 25 mm.

Preferably, the substrate tube holder of the device according to the invention is used to support the substrate tube according to method step (b). This is explained in more detail below:

After completion of the deposition process, the substrate tube can remain in the composite of substrate tube and SiO₂ body, or it is removed from the substrate tube-SiO₂ body composite. A substrate tube that remains in the substrate tube-SiO₂ body composite can become a part of the SiO₂ blank; it is made of quartz glass, for example. A substrate tube that remains in the substrate tube-SiO₂ body composite and becomes part of the SiO₂ blank preferably has an inner diameter of at least 250 mm. Its wall thickness is, optionally, preferably in the range from 4 to 10 mm. A substrate tube, which is removed from the substrate tube-SiO₂ body composite after the deposition process or at a later stage of the process, is preferably made of SiC, SiSiC, Al₂O₃, or another ceramic material, or of graphite. It preferably has an outer diameter of at least 250 mm. Its wall thickness is, optionally, preferably in the range from 5 to 30 mm.

The wall thickness of the substrate tube is thus small relative to its outer diameter and is as a rule less than 20% of the outer diameter of the substrate tube. On the one hand, the substrate tube thus has a low weight, which reduces the dynamics of the rotational movement and facilitates handling and alignment, and on the other it has a low thermal mass, which keeps the heat dissipation and the formation of thermal stresses within the wall low.

On the other hand, the wall thickness of the substrate tube is large enough to support a large-volume SiO₂ body. Therefore, the wall thickness of the substrate tube is preferably at least 1% of the outer diameter of the substrate tube. The preferred wall thickness “W_{S}” (in mm) can also depend on the length of the substrate tube. It is advantageous if the wall thickness also increases with increasing length of the substrate tube. Therefore, W_{S} can alternatively be set depending on the outer diameter D_{S} of the substrate tube (in mm), additionally taking into consideration the length of the substrate tube “L_{S}” (in mm), as follows: W_{S}<0.2*(L_{S}/2,000 mm)*D_{S}.

The substrate tube holder is used to support and rotate the substrate tube. It comprises the clamping device and a clamping mechanism with two pressure units, one of which rests against each end face of the substrate tube. The clamping mechanism causes the substrate tube to be clamped by applying an axial clamping force to its end faces at both sides.

The rotationally fixed mounting and rotation is effected by clamping the substrate tube between a first pressure unit abutting the first end face and a second pressure unit abutting the second end face. For this purpose, the substrate tube holder is designed to generate an axial contact pressure on the first end face and on the second end face with a force component acting in the direction of the longitudinal axis of the substrate tube. The axial contact pressure acts on the first and/or on the second pressure unit with a force component acting in the direction of the substrate tube longitudinal axis. This contact pressure is transmitted by means of the pressure units to the end faces of the substrate tube, so that the substrate tube is clamped and held in a rotationally fixed manner between the pressure units on both sides. For the axial clamping, the applied axial clamping force and, in the simplest case, a non-positive connection based solely on friction between the substrate tube and the pressure units abutting the end faces is sufficient. The elimination of the otherwise usual positive-fit or material connection between the substrate tube and the clamping device results in an additional degree of freedom for movements of the substrate tube in the radial direction, and, in this respect, a certain mechanical decoupling of the substrate tube from a clamping device, even if the pressure units are fixedly connected to the clamping device. As a result, thermally induced changes in the diameter that occur during the deposition process can be compensated for, or these diameter changes can be permitted without mechanical stresses building up between the clamping device and the substrate tube.

The clamping mechanism can also contribute to compensating for thermal expansion in the direction of the substrate tube longitudinal axis.

The pressure units on both sides transmit both the rotational movement of the clamping device and the component of the contact pressure generated by the at least one force element and acting in the direction of the substrate tube longitudinal axis onto the substrate tube end faces. In the simplest case, the rotational movement of the substrate tube can also be achieved solely by the axial non-positive connection (static friction) between the substrate tube and the contact pressure units abutting the end faces of the substrate tube. Only a sufficiently high contact pressure is required for this purpose. Supporting this, driver elements can be provided on the end face of the substrate tube and/or on one or both of the pressure units that abut it, which driver elements create a positive fit for the rotational movement and do not eliminate the above-mentioned additional degree of freedom for movements of the substrate tube in the radial direction.

The pressure units themselves on both sides each consist of one component or of several components. In the preferred case, they are identical in design. The components directly abutting the end faces of the substrate tube are, for example, plate-shaped or ring-shaped, or form spherical or ellipsoidal segments. In the simplest case, the surfaces abutting the substrate tube end faces are flat; they can also be designed to be curved or stepped.

The first and second pressure units are pressed against each other as a result of the action of the at least one force element, so that the pressure units exert an axial contact pressure on the substrate tube that is sufficient for the support and rotational movement of the substrate tube. It is sufficient for this if the at least one force element acts on only one of the two pressure units, so that this pressure unit transmits the contact pressure to the respective substrate tube end face; if necessary, the other pressure unit—situated opposite in the direction of the substrate tube longitudinal axis—forms a passive abutment without the need for a further force element.

In a preferred procedure, the axial contact pressure on the first pressure unit is generated by means of a first spindle connected to a clamping device and rotatable about the axis of rotation, and the axial contact pressure on the second pressure unit is generated by means of a second spindle connected to the clamping device and rotatable about the axis of rotation, wherein the first spindle is mounted on or linked to the first pressure unit in a rotationally fixed but pivotable manner, and wherein the second spindle is mounted on or linked to the second pressure unit in so as to be rotationally fixed but movable relative to one another.

The first spindle and the second spindle form mechanical guide elements and are each assigned to a pressure unit. They transmit the rotational movement of the clamping device and the axial contact pressure to their respective pressure unit. The spindles are designed in one piece or consist of several components; in the simplest case, for example, they are designed as a tube, solid rod, or cone. Each of the two spindles is connected to its corresponding pressure unit for force transmission. The connection is rotationally fixed, but allows at least a pivoting movement.

For example, it is designed as a joint, such as a hinge, ball joint, universal joint, or cardan joint, or as a fixed bearing or floating bearing, such as a ball bearing, conical bearing, roller bearing, or cardan bearing or mount. This pivoting connection between the pressure unit and the spindle results in an additional decoupling between the clamping device and the substrate tube, which helps to compensate for alignment, positional, or dimensional deviations. For example, in this way, end faces that are not exactly perpendicular to the longitudinal axis of the substrate tube can be compensated for, and wobbling movements caused by the substrate tube not being absolutely precisely centered can be compensated for.

In the simplest and particularly preferred case, the first spindle has a free, distal end on which the first pressure unit is pivotably mounted, and the second spindle also has a free distal end on which the second pressure unit is pivotably mounted.

The two spindles therefore transfer the contact pressure and the rotational movement to the substrate tube on the one hand, and support the pressure units on the other. These units are seated on the corresponding distal spindle end.

In the region of the distal end of the first and second spindle, in each case there is arranged at least one support element on which the corresponding spindle can roll. The at least one support element is used to support the spindle, and especially when the substrate tube and SiO₂ body are heavy in weight.

Particularly preferably, the pivoting connection between the spindle and the pressure unit is designed as a floating bearing and preferably comprises a cardan ball cone seat. Here, the seat on the spindle side is conical in shape, and the pressure unit movably mounted thereon has a spherical or radius section that interacts with the seat—or conversely: the seat on the spindle side has a spherical or radius section that corresponds with the concavely curved pressure unit movably mounted thereon.

In particular, in the case of very long substrate tubes having a length of more than 2 m, an additional stabilization of the axis of rotation can be helpful.

With regard to this, a substrate tube holder is advantageously used that comprises a centering unit comprising at least one tubular or rod-shaped centering support extending through the through-opening of the substrate tube and between the first pressure unit and the second pressure unit.

The centering support is preferably mounted loosely in the region of the respective pressure units and is mechanically decoupled from the spindles on both sides in such a way that it does not hinder the axial movement of the spindles to compensate for changes in length.

For example, a linkage can be used for this purpose which extends through the through-opening in the substrate tube from one spindle to the opposite spindle. The linkage consists, for example, of two or more rods which are each uniformly distributed about the axis of rotation and are connected directly or indirectly (via the corresponding mounted intermediate element) to the spindles on both sides.

Alternatively or in addition, in a particularly preferred procedure, it is provided that the first spindle be designed as a hollow spindle having a first inner bore, and that the second spindle be designed as a hollow spindle with a second inner bore, and that the centering support project with a first end into the first inner bore and with a second end into the second inner bore.

The first and the second spindle are here designed as hollow spindles with inner bores. The inner bores are either designed as through-holes, or the hollow spindles are closed at one side at their proximal end (facing the clamping device). In the simplest case, the inner bores have a circular cross-section; however, they can also have a cross-section deviating from the circular shape, such as an oval or a polygonal cross-section. The internal cross-sections of the first hollow spindle and of the second hollow spindle are the same or different from one another. The internal cross-sections of the hollow spindles are adapted to the respective external cross-sections of the centering supports—preferably in the sense of a clearance fit.

The centering support, which is part of the centering unit, has a centering support longitudinal axis and is, for example, rod-shaped or tubular. It extends completely through the through-opening of the substrate tube, but preferably ends in the inner bores of the hollow spindles on both sides. In the corresponding inner bore, the centering support is mounted according to the telescopic principle so as to be axially displaceable with little radial play. The gap between the inner wall of the hollow spindle and the outer wall of the centering support is as small as possible and is preferably in the range of a few tenths of a millimeter—for example, 0.2-0.5 mm. The centering support is thus supported on the inner wall of the inner bores of both hollow spindles and simultaneously centers them relative to one another in the axial direction in the sense of a coaxiality of the longitudinal axes of centering supports and hollow spindles. On the one hand, the clearance fit prevents overdetermination of the substrate tube bearing, and, on the other, an axial guidance is achieved that counteracts mutual tilting or twisting of the hollow spindles from the longitudinal axis of the substrate tube.

In a preferred procedure, the centering support is freely rotatable within the hollow spindle inner bores on both sides and does not also execute the hollow spindle rotational movement, or does so only partially. In another procedure, the centering support is mounted in rotationally fixed fashion inside the inner bores of the hollow spindle inner bores on both sides, so that it rotates along with the hollow spindles. The rotatably fixed mounting can be achieved, for example, by a non-circular inner geometry of at least one of the hollow spindles, for example by a polygonal or oval inner geometry, and an outer contour of the centering support adapted thereto in the sense of a key-lock combination.

In a preferred development of the procedure using a centering support, this support is freely movable in the first inner bore and in the second internal bore in the axial direction.

Here, the centering support ends inside the respective inner bores and can move freely therein in the axial direction (apart from friction). Due to the axial mobility of the centering support, differences in the thermal expansion between the centering support and the hollow spindles can be compensated for, and thus thermally induced stresses in the substrate tube holder can be avoided.

The free distance “a” between the oppositely situated hollow spindles is generally constant. The length of the centering support “L_{Z}” is greater than this free distance “a.” Under certain circumstances, the centering support can nevertheless slip completely out of one of the hollow spindle inner bores, if its movement play in the axial direction is large enough for this. This slipping out can be prevented, for example, by the length of the centering support “L_{Z}” comprising the free distance “a” plus an additional length (La+Lb) that takes into account the axial movement clearances on both sides in the first and second inner bores.

In particular, with regard to the effect of the centering support as an axial guide for the hollow spindles on both sides, it is advantageous if the centering support extends into both hollow spindles over a certain extension length La or Lb. The lengths La and Lb are preferably at least twice as large as the inner diameter of the respective hollow spindle. The inner diameter of the hollow spindles is preferably in the range of 40 mm to 100 mm.

On the other hand, for reasons of stability and in particular for the most effective possible guidance of the hollow spindles on both sides by means of the centering support, it can also be advantageous to limit the entire axial movement range “B_{Z}” of the centering support on both sides inside the hollow spindles and to design “B_{Z}” to be as large as necessary, but as small as possible. With regard to this, it has proven useful if the following applies for B_{Z}: B_{Z}<20 mm, and preferably 5 mm<B_{Z}<15 mm.

The entire axial movement clearance of the centering support inside the hollow spindles in the axial direction is limited to a few millimeters. This is usually sufficient to compensate for the CTE differences between the hollow spindles and the centering support in the axial direction. The limitation can take place, for example, by stop elements projecting into the inner bores of the hollow spindles, or by a narrowing, or by a closure of the inner bores of the hollow spindles.

In a particularly preferred development of the procedure using a centering support, it is provided that the centering unit comprise centering elements which are placed on the centering support inside the through-hole in the substrate tube, and of which a first centering element is arranged in the region of the first substrate tube end face, and a second centering element is arranged in the region of the second substrate tube end face.

The centering elements are inserted into the substrate tube through-hole in the region of both ends. They serve to guide the substrate tube and act as a “collapse protection” against slipping out. Accordingly, they have an outer contour which is adapted to the inner contour of the substrate tube through-hole. They are designed, for example, as a circular ring, polygonal ring, or in a star shape with outwardly pointing support arms. The diameter of the enveloping circle around the centering element is smaller than the inside diameter of the substrate tube through-hole.

The inner contour of the centering elements is preferably adapted to the outer contour of the centering support in such a way that they are seated on the centering support with a clearance fit in a sliding manner. For example, in the case of a circular configuration, the inner diameter of the centering elements is larger by 0.5 to 2 mm than the outer diameter of the centering support.

The centering elements facilitate the installation of the substrate tube holder and reduce the risk of the substrate tube slipping out of the axial clamping when used in the deposition process. To reduce the deflection of the substrate tube, at least one further centering element can be arranged in the region between the end centering elements. The centering elements preferably consist of graphite or of another graphite-containing material.

The SiO₂ blank to be produced consists of synthetic silicon dioxide, whose CTE is low. It varies depending on the composition and production method, and at room temperature is about 0.5 μm/m/° K (0.5×10⁻⁶/° K). A metal is preferably selected as the material for the spindles. Metals are generally distinguished by their ability to absorb mechanical energy during plastic deformation (toughness) and are therefore able to compensate for mechanical impulses during the deposition process. Particular preference is given to metals having high chemical resistance, such as stainless steel (with a CTE in the range of 10 μm/m/° K to 17 μm/m/° K, depending on the alloy), and/or metals having a coefficient of thermal expansion comparable to silicon dioxide, such as iron nickel alloys known under the collective designation, “INVAR,” the CTE of which is typically in the range of 1.2 μm/m/° K or below.

The at least one deposition burner generates a burner flame, the hottest point of which is generally located spatially in front of or on the surface of the SiO₂ body to be deposited. The region around this hottest point is also known as the “reaction region.”

With regard to this, in a preferred procedure, the maximum dimension of the spindles in the radial direction, such as the outer diameter in the case of a circular spindle cross-section, is significantly smaller than the substrate tube outer diameter; for example, it is at least 100 mm smaller. This ensures that the spindles are outside the “reaction region” of the at least one deposition burner.

The device for carrying out the method has a first side (for example, the left side) and a second side (for example, the right side). When the following explanations refer only to the first of these two sides, the second side is designed to be essentially identical or equivalent to the first side, unless expressly stated otherwise.

It has proven successful if the first pressure unit has a first pressure transmission element and a first buffer element connected thereto in a rotationally fixed manner and preferably consisting of a graphite-containing material, wherein the pressure transmission element is mounted on or linked to the first spindle in a rotationally fixed but pivotable manner, and wherein the first buffer element is arranged between the pressure transmission element and the substrate tube, and abuts the first substrate tube end face.

The first pressure transmission element is part of the first pressing unit. It is designed to transmit the axial contact pressure generated by the at least one force element onto the first substrate tube end face, or to serve as an abutment for the first substrate tube end face if the axial contact pressure generated by the force element also acts, or acts exclusively, on the second substrate tube end face. The pressure transmission element interacts directly or indirectly (i.e., via an intermediate element) with the first spindle, on which or to which it is mounted or linked in a rotationally fixed but pivotable manner. For example, the pressure transmission element has a central opening with a circumferential opening edge, which rests on the first spindle. The pressure transmission element preferably consists of metal—for example, of stainless steel.

The buffer element is arranged between the pressure transmission element and the first substrate tube end face. It serves on the one hand to improve the clamping effect, and on the other to absorb pulses in the axial or azimuthal direction which would otherwise act on the comparatively shock-sensitive end face. The buffer element is for example designed to be annular or star-shaped. It preferably has a low hardness and allows a comparatively high contact pressure to be applied without damaging the substrate tube end face, and it generates a high enough friction that the rotational movement is transmitted. A suitable material is, for example, graphite which, due to its lubricating property, allows a radial slippage of the tube end faces on the graphite and thus allows a radial thermal expansion of the substrate tube, but always has enough frictional force to transmit the pulses and forces during azimuthal acceleration.

The force flow of the contact pressure is here: force element (for example, a spring-loaded chuck) 4 first pressing unit with first spindle 4 joint/pivotable bearing 4 first pressure transmission element 4 first buffer element 4 first substrate tube end face.

The first buffer element can be designed as a stepped annular disk which has a hollow cylindrical section with an outwardly projecting flange, wherein the flange abuts the first substrate tube end face, and the hollow cylindrical section projects into the through-hole in the substrate tube. The stepped-disk buffer element engages under the inner wall of the substrate tube with little play and simultaneously acts as a centering element. This is one way of ensuring the position of the first centering element in the region of the first substrate tube end face, if this appears necessary or advantageous. In this embodiment, the centering element and the buffer element are designed in one piece.

On the other hand, the buffer element is exposed to high forces and can wear out comparatively quickly. It is also advantageous if the centering element and the buffer element can be thermally decoupled—for example, by a gap. As a wear part, the buffer element is preferably easy and inexpensive to replace. With this in mind, it has proven to be advantageous if the first centering element is connected to the first buffer element in a detachable and non-rotatable manner.

This is a further possibility for ensuring the positioning of the first centering element in the region of the first substrate tube end face, if this appears necessary or advantageous. The detachable connection is made using screws, for example. The buffer element can thus be easily replaced—for example, in the event of wear. The torsional strength is also ensured by connection that is only loose between the buffer element and the centering element, which on the one hand allows mechanical play, and on the other leaves a gap between the buffer element and the centering element for thermal decoupling. In this case, for example, screws are provided that are guided with play in bores in the buffer element and in the centering element so that the articulated connection between the respective spindle and the pressure unit is not hindered. The screws bring about a positive-fit connection for the rotational movement and can thus serve as driver elements for the rotational movement of the substrate tube.

In a procedure using a first buffer element, it has also proven to be advantageous if this buffer element projects beyond the pressure transmission element and the substrate tube in the radial direction.

During the OVD external deposition process, the flame of the at least one deposition burner strikes the lateral surface of the substrate tube or the forming SiO₂ body and can then be deflected laterally so that it spreads tangentially to the body lateral surface in the direction of the end regions of the SiO₂ body. As a result of the radial protrusion of the buffer element relative to the pressure transmission element, the latter is located in the flame shadow, and is thereby largely protected from thermal and corrosive stress, to which, on the other hand, the buffer element is exposed. The height of the radial protrusion is preferably in the range of 1 cm to 3 cm.

The substrate tube holder preferably has a compensation mechanism for compensating for thermal expansion in the direction of the substrate tube longitudinal axis. The compensation mechanism and the clamping mechanism can have common components. For example, the compensation mechanism usually comprises a spring element, wherein, in a preferred procedure, the force element of the clamping mechanism also comprises a spring element, which is at the same time a component of the compensation mechanism. The spring element is thus both a component of the compensation mechanism and a component of the clamping mechanism of the substrate tube holder. The spring element is designed, for example, as a chuck spring-mounted on one or both sides.

### Definitions and Measurement Methods

Individual terms of the above description are further defined below. The definitions are part of the description of the invention. For terms and measuring methods that are not specifically defined in the description, the interpretation according to the International Telecommunication Union (ITU) is relevant. In the event of an inconsistency between one of the following definitions and the rest of the description, the statements made in the description take precedence.

### Tubular SiO₂ Blank

The result of the deposition process is a tubular composite body made of a substrate tube and of a body of synthetic silicon dioxide. Depending on the temperature during the deposition process, the body of synthetic silicon dioxide is either a porous “soot body” or a body of more or less transparent quartz glass. Here, it is referred to as the “SiO₂ body.” The SiO₂ body is the sole component of the tubular SiO₂ blank, or the substrate tube is a further component of the SiO₂ blank and may limit its inner bore. A substrate tube made of a material other than quartz glass is not part of the SiO₂ blank.

### Component Made of Synthetic Quartz Glass

A component made of synthetic quartz glass is obtained by mechanical, thermal, or chemical processing of a tubular SiO₂ blank. Further mechanical processing includes sawing, cutting, milling, grinding, and polishing the inner and outer contours. Thermal further processing includes thermal drying, sintering, vitrification, melting, forming, and tempering. Chemical further processing comprises chemical or thermal or vacuum drying (dehydration treatment), doping and etching. The component is a ready-to-use quartz glass product or a semi-finished product therefor—for example, a quartz glass tube or a quartz glass ring.

### Quartz Glass/Synthetic Quartz Glass/Synthetic Silicon Dioxide

Quartz glass and synthetic silicon dioxide are understood here to mean glass with a SiO₂ content of at least 87 wt. %. It is doped (SiO₂ content=100%) or contains dopants such as fluorine, chlorine, nitrogen, carbon, or oxides of boron, germanium, rare earth metals, aluminum, or titanium.

Quartz glass is, for example, a melted product from naturally occurring SiO₂ raw material (natural quartz glass), or it is synthetically produced (synthetic quartz glass), or consists of mixtures of these quartz glass types. Synthetic, transparent quartz glass is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid.

### Sintering/Vitrification

“Sintering” or “vitrification” here denotes a method step in which a SiO₂ body of porous silicon dioxide is treated in an oven at high temperature. Sintering/vitrification takes place in inert gas, an atmosphere containing hydrogen and/or helium, or under vacuum. Vacuum means an absolute gas pressure of less than 2 mbar. The result of vitrification/sintering is a “tubular blank made of synthetic silicon dioxide.”

### Substrate Tube Outer Diameter/Substrate Tube Inner Diameter

The substrate tube cross-section has a circular outer contour or an outer contour that deviates from the round shape. If the outer contour deviates from the round shape, the local “outer diameter value” is given by the diameter of the (smallest) circumference.

The substrate tube cross-section has a circular inner contour or an inner contour deviating from the round shape. If the inner contour deviates from the round shape, the local “inner diameter value” is given by the diameter of the (largest) inscribed circle.

In the longitudinal section of the substrate tube, the local values for the outside diameter are constant or not constant over the entire length of the substrate tube. In the case of constant outer diameter values, the substrate tube has a cylindrical shape, seen from the outside. The non-constant outer diameter values can vary over the total length or over a partial length. The outer contour can change continuously or gradually, for example. In this case, the outer diameter results from the local outer diameter values averaged over the total length.

In the longitudinal section of the substrate tube, the local values for the outside diameter are constant or not constant over the entire length of the substrate tube. In the case of constant inner diameter values, the through-opening of the substrate tube is cylindrical. The non-constant inner diameter values can vary over the total length or over a partial length. The inner contour can change continuously or gradually, for example. In this case, the inner diameter results from the local inner diameter values averaged over the total length.

### Clearance Fit

The clearance fit is determined, for example, on the basis of the tolerance table according to DIN EN ISO 286—Part 2. In order to ensure a certain amount of axial mobility between the respective bore and the spindle, the tolerance zones must be matched to one another so that the maximum dimension of the spindle is always smaller than the minimum dimension of the bore. Suitable tolerance zones for the bore are, for example, H, G, F, and E, and those for the spindle are, for example, g, f, and e.

### BRIEF DESCRIPTION OF THE DRAWINGS

The invention is explained in more detail below with reference to an exemplary embodiment and a drawing. In detail, in a schematic representation,

FIG. 1 shows a device for producing a tubular SiO₂ blank in a first embodiment of a substrate tube holder in a longitudinal section,

FIG. 2 shows a device for producing a tubular SiO₂ blank from synthetic silicon dioxide in a second embodiment of a substrate tube holder in a longitudinal section, partly in detail, and

FIG. 3 is an enlarged view of a portion of the substrate tube holder of FIG. 2.

### DETAILED DESCRIPTION

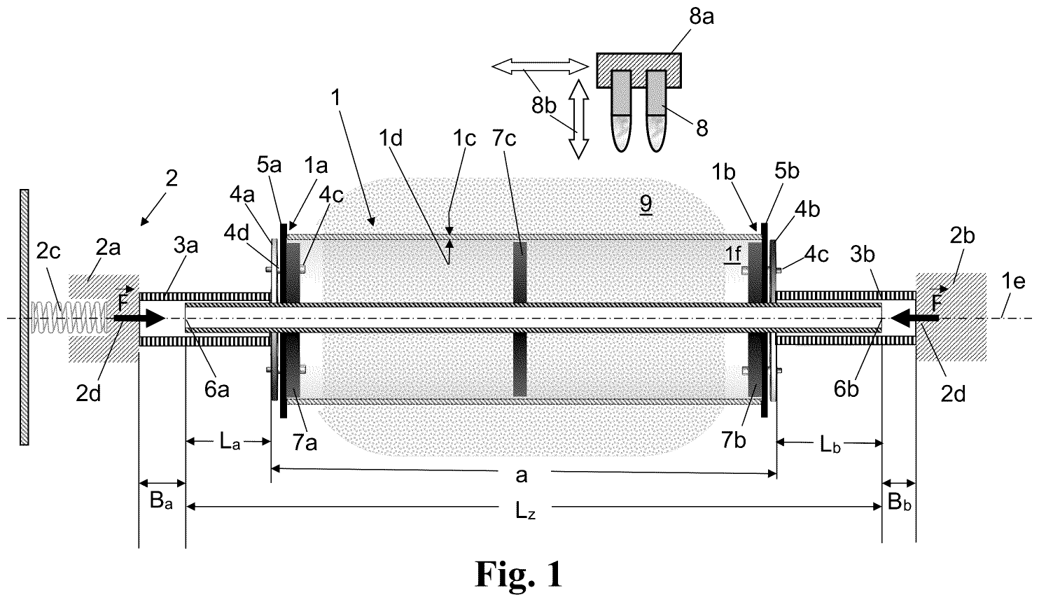

The device shown schematically in FIG. 1 comprises a glass lathe 2 for holding and rotating a substrate tube 1 made of SiSiC. The substrate tube 1 has a left end face 1a, a right end face 1b, an outer lateral surface 1c, an inner lateral surface 1d, a horizontally oriented longitudinal axis 1e, and a cylindrical through-hole if. The substrate tube 1 has a length of 2 m, an outer diameter of 280 mm, and a wall thickness of 20 mm. The inner diameter is thus 240 mm.

The glass lathe 2 is indicated by two, oppositely situated chucks 2a, 2b, of which the chuck 2a is spring-loaded, as indicated by the compression spring 2c. The compression spring 2c generates a pressure force F that presses the two chucks 2a, 2b against each other, as indicated by the directional arrows 2d.

A hollow spindle 3a, 3b made of stainless steel is clamped in each of the chucks 2a, 2b at their proximal ends. In the ideal case, the axes of rotation of the hollow spindles 3a, 3b run coaxially with the substrate tube longitudinal axis 1e. The hollow spindles 3a, 3b have an outer diameter of 90 mm and an inner diameter of 82 mm.

The distal ends of the hollow spindles 3a, 3b are pivotably connected to an annular pressure plate 4a, 4b made of stainless steel. For this purpose, the distal ends of the hollow spindles 3a, 3b taper conically and, as a result of the force of the spring 2c, press against the corresponding pressure plate 4a, 4b. Here, the conical end protrudes into the center bore of the respective annular pressure plate 4a, 4b and abuts the inner edge of the center bore.

The pressure plates 4a, 4b each abut buffer disks 5a, 5b made of graphite, which in turn abut the substrate tube end faces 1a and 1b respectively. The buffer disks 5a, 5b have a central bore whose diameter corresponds to that of the pressure plates and which run coaxially with these. The pressure plates 4a, 4b have an outer diameter that is 10 mm smaller than the outer diameter of the substrate tube. The buffer disks 5a, 5b have an outer diameter that extends beyond the outer diameter of the substrate tube 1 by 40 mm.

A tubular centering support 6 made of SiSiC with a total length L_{Z} and an outer diameter of 80 mm extends through the substrate tube through-hole if and through the center bores of pressure plates 4a, 4b and buffer disks 5a, 5b. One end 6a of the centering support 6 projects into the hollow spindle 3a over a length Lₐ of at least 500 mm and ends inside it, leaving a variable movement clearance Bₐ of approximately 6 mm. The other end 6b protrudes into the hollow spindle 3b over a length Le of 600 mm and ends inside it, leaving a variable movement clearance B_{b} also of about 6 mm. The entire movement clearance B₀=Bₐ+B_{b} for the centering support 6 within the hollow spindles 3a, 3b is thus 12 mm. The outer diameter of the centering support 6 is constant over its length and is adapted with a clearance fit to the inner diameter of the hollow spindles 3a, 3b and telescopically displaceable therein.

Three centering rings 7a, 7b, 7c made of graphite are placed on the centering support 6. The centering ring 7a is located in the region of the left substrate tube end face 1a, the centering ring 7b is located in the region of the right substrate tube end face 1b, and the centering ring 7c is located approximately in the middle of the substrate tube through-hole if. All centering rings 7a, 7b, 7c have an outer diameter that is matched to the inner diameter of the substrate tube with a clearance fit, and they have an inner diameter that is matched to the outer diameter of the centering support with a clearance fit.

The end centering ring 7a, the buffer disk 5a, and the pressure disk 4a are loosely connected to each other by means of screws 4c. The screws 4c have a thread which adjoins a cylinder portion 4d. The screw thread engages in each case in an internal thread in the pressure disk 4a, so that the cylinder portion 4d lies firmly against the pressure disk 4a in the tightened state. The length of the cylinder portion 4d is greater than the total thickness of the component stack of centering ring 7a and buffer disk 5a, so that the heads of the screws 4c do not rest against the centering ring 7a, but a gap remains between the centering ring 7a and the screw heads. Furthermore, the through-holes for the passage of the cylindrical portion 4d in the buffer disk 5a and in the centering ring 7a are greater than the diameter of the cylinder portion 4d, so that the screws 4c can also be slightly inclined in the through-holes and thus do not hinder the possible pivoting movements of the joint. This loose connection is therefore suitable both for allowing thermally induced changes in length between components of the substrate tube holder and for compensating for deviations in the target dimensions, positioning, and alignment of the components. In addition, the screws 4c provide a certain torsional strength between the buffer disk 5a and the pressure disk 4a during the rotational movement of the substrate tube 1, and, in this respect, serve as driving elements for this rotational movement. The same applies to the connection of the centering ring 7b, the buffer disk 5b, and the pressure disk 4b; a gap (not visible in the figure) is provided between the centering ring 7a, 7b and the buffer disk 5a, 5b for the purpose of thermal decoupling.

Several deposition burners 8 for generating SiO₂ particles are mounted on a common slide 8a, by means of which they can be moved reversibly and transversely along the outer lateral surface 1c of the substrate tube 1 or along a forming SiO₂ soot body 9, and can be displaced perpendicularly thereto, as indicated by the directional arrows 8b.

In the following, an example of the manufacture of a component made of quartz glass is explained with reference to FIG. 1.

Oxygen and hydrogen are supplied to the deposition burners 8 as burner gases, and a gas stream containing SiCl₄ or another silicon-containing starting material is supplied as feed material for the formation of SiO₂ particles. These components are converted into SiO₂ particles in the relevant burner flame, and these SiO₂ particles are deposited on the substrate tube 1 rotating around the longitudinal axis 1e, forming the soot body 9 from porous SiO₂ soot.

To rotate the substrate tube 1, the glass lathe 2 transmits a torque to the hollow spindles 2a, 2b. At the same time, a pressure force F acting in the axial direction is generated by means of the compression spring 2c, which pressure force presses the two hollow spindles 3a, 3b against one another and which, depending on the deflection of the spring from the spring rest length, is in the range between 0.5 kN and 10 kN. The initially set pressure force F of 1 kN, for example, is applied to the pressure plates 4a, 4b, the buffer disks 5a, 5b, and thus also to the substrate tube end faces 1a, 1b. This pressure force F creates a frictional connection between the buffer disks 5a, 5b, which is sufficient to hold the inherent weight of the substrate tube 1 and the weight of the soot body 9. The centering rings 7a, 7b, 7c are used only to prevent the substrate tube 1 from slipping or bending unexpectedly. A certain amount of axial guidance is provided by the interaction of hollow spindles 3a, 3b and centering support 6, which, due to the mechanical play present, compensates for any radial offsets and angular differences between the axes of rotation of the hollow spindles 3a, 3b, and avoids mechanical stresses.

The deposition process is terminated as soon as the soot body 9 has reached a predetermined outer diameter which, depending on the density of the soot layer, leads to the predetermined outer diameter of the hollow cylindrical quartz glass blank, plus a predetermined allowance of 1 mm, for example.

The substrate tube 1 is removed, and the soot body 9 is subjected to a dehydration treatment. The subsequent vitrification of the soot body takes place in a zone sintering furnace under vacuum or in an atmosphere of gases that diffuse quickly in quartz glass, such as helium and hydrogen, and therefore do not cause bubbles. The quartz glass tube obtained in this way has a length of 1,750 mm, an inner diameter of 280 mm, and a wall thickness of 45 mm.

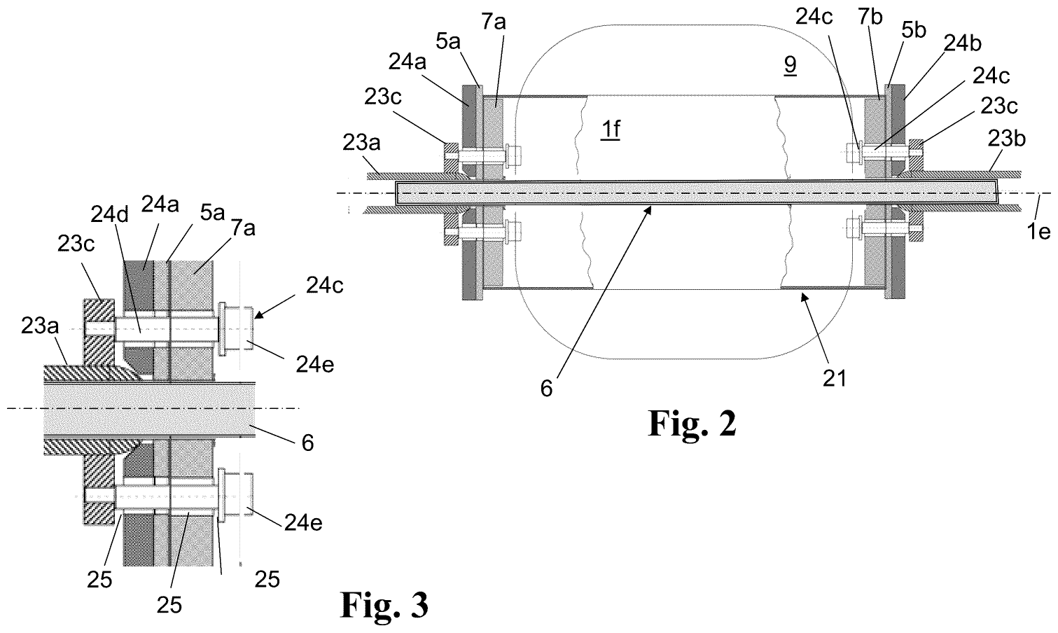

When the same reference numerals are used in FIG. 2 and in FIG. 3 as in FIG. 1, these designate identical or equivalent components or components of the device.

The device shown schematically in FIG. 2 differs from that of FIG. 1 essentially in the type and characteristics of the substrate tube holder and the substrate tube 21, which here is made of quartz glass. The substrate tube 21 has a length of 1.5 m, an outer diameter of 280 mm, and a wall thickness of 5 mm. The inner diameter is thus 270 mm.

The hollow spindles 23a, 23b, which are each clamped in clamping chucks with their proximal end, are made of stainless steel. In the ideal case, the axes of rotation of the hollow spindles 23a, 23b run coaxially with the substrate tube longitudinal axis 1e. The hollow spindles 23a, 23b have an outer diameter of 100 mm. A circumferential extension arm 2c is welded in each case in the region of the distal ends of the hollow spindles 23a, 23b.

The pivoting connection between the hollow spindles 23a, 23b and the corresponding pressure plates 24a, 24 is designed here as a floating bearing and preferably comprises a cardan ball cone seat. Here, the distal ends of the hollow spindles 23a, 23b each form a convexly curved seat which has a spherical or radius section on which the pressure plate 24a or the pressure plate 24b is movably mounted by having a concavely curved spherical or radius section cooperating with the convexly curved seat.

FIG. 3 is an enlarged view of the pivoting connection between the hollow spindles 23a, 23b and the respective pressure plates 24a, 24b. The end centering ring 7a, the buffer washer 5a, and the pressure disk 24a form a stack of components that are loosely connected to each other by means of threaded screws 24c, each of which engages in a thread in the extension arm 23c. The cylindrical portion 24d has a length which is greater than the total thickness of the component stack consisting of centering ring 7a, buffer disk 5a, and pressure disk 24a. In addition, the width of the bore for receiving the threaded screws 24c in the component stack is significantly larger than the diameter of the cylinder portion 24d. This leads to several gaps 25 remaining both between the screw head 24e and the centering ring 7a and between the pressure plate 24 and the extension arm 23c, even with a fixedly tightened threaded screw 24c, and along the cylinder portion 24d. The gaps 25 ensure that the connection between the hollow spindles 23a, 23b and the corresponding pressure plates 24a, 24b remains pivotable. At the same time, the screws 24c serve as driver elements for the rotational movement of the substrate tube 1.

What is claimed is:

1. A device for producing a tubular SiO₂ blank in an external deposition process, comprising:
a substrate tube, which has a substrate tube longitudinal axis, a substrate tube length, a first substrate tube end face, a second substrate tube end face, a substrate tube outer lateral surface, a substrate tube inner lateral surface, a substrate tube outer diameter, a substrate tube inner diameter, a substrate tube wall thickness, and a continuous through-opening running coaxially with the substrate tube longitudinal axis, and
a substrate tube holder, which comprises a clamping device and which is designed to support the substrate tube and to rotate the substrate tube about an axis of rotation running coaxially with or parallel to the longitudinal axis of the substrate tube,
wherein the substrate tube holder comprises a clamping mechanism which comprises a first pressure unit abutting the first substrate tube end face, a second pressure unit abutting the second substrate tube end face, and at least one force element which is designed to generate an axial contact pressure with a force component acting in the direction of the longitudinal axis of the substrate tube, which force component causes the substrate tube to be clamped between the first pressure unit and the second pressure unit.

2. The device according to claim 1, wherein the clamping device comprises a first spindle, which can rotate about the axis of rotation, and a second spindle, which is situated axially opposite the first spindle in the direction of the longitudinal axis of the substrate tube and can rotate about the axis of rotation, wherein the first spindle is mounted on or linked to the first pressure unit in a rotationally fixed but pivotable manner and transmits the axial contact pressure to this first pressure unit, and wherein the second spindle is mounted on or linked to the second pressure unit so as to be rotationally fixed but movable relative to one another and transmits the axial contact pressure to this second pressure unit.

3. The device according to claim 2, wherein the first spindle has a free, distal end on which the first pressure unit is pivotably mounted, and wherein the second spindle has a free distal end on which the second pressure unit is pivotably mounted, wherein the pivotable bearing is preferably designed as a ball, conical, roller or plain bearing, and preferably comprises a cardan ball and cone seat.

4. The device according to claim 2, wherein the substrate tube holder comprises a centering unit comprising at least one tubular or rod-shaped centering support extending through the through-opening of the substrate tube and between the first pressure unit and the second pressure unit.

5. The device according to claim 4, wherein the first spindle is designed as a hollow spindle comprising a first inner bore, and wherein the second spindle is designed as a hollow spindle comprising a second inner bore, and wherein the centering support projects with a first end into the first inner bore and with a second end into the second inner bore.

6. The device according to claim 5, wherein the centering unit comprises centering elements which are placed on the centering support inside the through-hole in the substrate tube, and of which a first centering element is arranged in the region of the first substrate tube end face, and a second centering element is arranged in the region of the second substrate tube end face.

7. The device according to claim 2, wherein the first pressure unit comprises a first pressure transmission element and a first buffer element connected thereto in a rotationally fixed manner and preferably consisting of a graphite-containing material, wherein the pressure transmission element is mounted on or linked to the first spindle in a rotationally fixed but pivotable manner, and wherein the first buffer element is arranged between the pressure transmission element and the substrate tube and abuts the first substrate tube end face.

8. The device according to claim 7, wherein the first buffer element projects beyond the pressure transmission element and the substrate tube in the radial direction.

9. The device according to claim 1, wherein the first pressure unit comprises a pressure surface which abuts the first substrate tube end face and consists of a graphite-containing material.

10. The device according to claim 1, wherein the substrate tube has a wall thickness which is less than 20% of the outer diameter of the substrate tube.

11. The device according to claim 1, wherein the substrate tube holder comprises a compensation mechanism for compensating for thermal expansion in the direction of the longitudinal axis of the substrate tube, and wherein the force element of the clamping mechanism is preferably a spring element and at the same time a component of the compensation mechanism.

12. The device according to claim 2, wherein, at least one support element, on which the corresponding spindle can roll, is arranged in the region of the distal end of the first spindle and/or the second spindle.

13. A method for producing a tubular SiO₂ blank in an external deposition process, comprising the following method steps:
(a) providing a substrate tube which has a substrate tube longitudinal axis, a substrate tube length, a first substrate tube end face, a second substrate tube end face, a substrate tube outer lateral surface, a substrate tube inner lateral surface, a substrate tube outer diameter, and a continuous through-opening running coaxially with the substrate tube longitudinal axis,
(b) supporting the substrate tube in a substrate tube holder comprising a clamping device,
(c) rotating the substrate tube about an axis of rotation running coaxially with or parallel to the longitudinal axis of the substrate tube,
(d) depositing SiO₂ particles on the outer lateral surface of the substrate tube by means of at least one deposition burner, forming the tubular SiO₂ blank,
wherein the substrate tube holder is used to generate an axial contact pressure on the first end face and on the second end face with a force component acting in the direction of the longitudinal axis of the substrate tube, which causes the substrate tube to be clamped between a first pressure unit abutting the first end face and a second pressure unit abutting the second end face.

14. The method according to claim 13, wherein a substrate tube holder of a device for producing a tubular SiO₂ blank in an external deposition process, comprising:
a substrate tube, which has a substrate tube longitudinal axis, a substrate tube length, a first substrate tube end face, a second substrate tube end face, a substrate tube outer lateral surface, a substrate tube inner lateral surface, a substrate tube outer diameter, a substrate tube inner diameter, a substrate tube wall thickness, and a continuous through-opening running coaxially with the substrate tube longitudinal axis, and
a substrate tube holder, which comprises a clamping device and which is designed to support the substrate tube and to rotate the substrate tube about an axis of rotation running coaxially with or parallel to the longitudinal axis of the substrate tube,
wherein the substrate tube holder comprises a clamping mechanism which comprises a first pressure unit abutting the first substrate tube end face, a second pressure unit abutting the second substrate tube end face, and at least one force element which is designed to generate an axial contact pressure with a force component acting in the direction of the longitudinal axis of the substrate tube, which force component causes the substrate tube to be clamped between the first pressure unit and the second pressure unit,
is used to support the substrate tube according to method step (b).

15. The method according to claim 13, wherein a substrate tube is used which consists of SiC, SiSiC, Al₂O₃, or another ceramic material, or of graphite, and which has an outer diameter of at least 250 mm, or wherein a substrate tube is used which consists of quartz glass and which has an inner diameter of at least 250 mm.
